(19) United States
(12) Patent Application Publication
(10) Pub. No.: US 2021/0332579 A1
(43) Pub. Date: Oct. 28, 2021

(54) EXCHANGEABLE FILL VALVE SYSTEM AND METHODS

(71) Applicant: FLUIDMASTER, INC., San Juan Capistrano, CA (US)

(72) Inventors: Tuan Le, Fountain Valley, CA (US); Salvador Pena, San Juan Capistrano, CA (US); Gabriel Wong, San Juan Capistrano, CA (US)

(21) Appl. No.: 17/238,581

(22) Filed: Apr. 23, 2021

Related U.S. Application Data
(60) Provisional application No. 63/014,827, filed on Apr. 24, 2020.

(51) Int. Cl. E03D 1/32; F16K 31/34

(52) U.S. Cl. CPC E03D 1/32; F16K 31/34

(57) ABSTRACT

The disclosure is directed to an exchangeable fill valve system. In some embodiments, the system includes an interchangeable shank that enables attachment of different fill valve types. In some embodiments, the interchangeable shank enables different fill valve types to be removed from a fluid tank without also removing the interchangeable shank from the tank wall. In some embodiments, the interchangeable shank also houses an inline filter, where the filter can be accessed by disconnecting the fill valve. In some embodiments, the exchangeable fill valve system includes floats that capture fill water drives the floats down actuating a fill valve lever. In some embodiments, the floats include one or more holes that enable a timed discharge of the fill water from the floats.

### CROSS REFERENCE TO RELATED APPLICATIONS

This application claims the benefit of U.S. Provisional Patent Application No. 63/014,827, filed Apr. 24, 2020, the entire disclosure of which is incorporated by reference herein.

### BACKGROUND

Water systems, including, without limitation, water storage tanks and other water storage apparatus, improve quality of life across the globe. Fill valves enable tank automatic filling, helping ensure water supply without flooding issues.

Like all mechanical structures, a fill valve's moving parts are subject to wear and failure. As a result, the fill valves must be replaced from time to time. Prior art fill valves typically consist of a threaded water inlet stem that is integral to the fill valve that passes through an opening in the side of the tank. The water inlet stem has a flange above the threaded portion which seats around the hole in the tank. A complementary nut is then threaded to the stem protruding outside the tank until the stem flange and nut compress one or more gaskets against the wall of the tank. This compressive force holds the fill valve in place and seals the tank hole.

The replacement of the entire fill valve, including the stem, is a waste of material. As mentioned previously, only the movable mechanical parts typically fail. Static parts, such as the water inlet stem, can last for many years after a dynamic part has failed.

In addition, failure of mechanical parts of a fill valve can be the result of debris such as minerals or impurities in water supply. Using a filter is a known method for reducing impurities in water delivery systems, but integrating a filter that can be easily removed and cleaned into a fill valve has not been achieved in the past.

Because the internal parts are not readily accessible in prior art systems, repair and maintenance are not an option. The consumer must instead drain the tank, unthread the nut from the stem, remove the entire fill valve, and install a new one using the same steps in reverse.

Therefore, there is a need for an exchangeable fill valve system that reuses static parts such as the valve stem and that also enables filter maintenance to increase fill valve life.

### SUMMARY

In some embodiments, the system describes an exchangeable fill valve system comprising an interchangeable shank, a threaded stem, a threaded nut, a filter, and a fill valve stem. In some embodiments, the interchangeable shank comprises the threaded stem. In some embodiments, the threaded stem is configured to cooperate with the threaded nut to secure the interchangeable shank to a tank wall. In some embodiments, the tank wall is a vertical tank wall. In some embodiments, the interchangeable shank is configured to house at least a first portion of the filter. In some embodiments, the fill valve stem is configured to house at least a second portion of the filter. In some embodiments, the interchangeable shank is configured to be installed horizontal relative to a bottom of a tank. In some embodiments, a fluid conduit of the interchangeable shank is configured to extend substantially parallel to a horizontal tank bottom toward a tank interior.

In some embodiments, exchangeable fill valve system includes a fill valve. In some embodiments, the fill valve comprises a diaphragm configured to control a fluid flow through the interchangeable shank and the fill valve stem. In some embodiments, the interchangeable shank is configured to connect to the fill valve stem. In some embodiments, the fill valve further comprises a lever, a pin, and an inlet seal. In some embodiments, the fill valve stem further comprises a stem inlet, and an inlet edge. In some embodiments, actuation of the lever causes the pin to pull the inlet seal from the inlet edge of the inlet allowing fluid to flow therethrough.

In some embodiments, the fill valve further comprises a float. In some embodiments, at least a portion the interchangeable shank, the filter, the fill valve stem, the lever, and the float coexist along a common plane when the exchangeable fill valve system is assembled. In some embodiments, the common plane is configured to be substantially parallel to a bottom surface of the tank when the system is installed in the tank.

In some embodiments, the interchangeable shank comprises a shank fluid inlet and a shank fluid outlet. In some embodiments, the fill valve stem comprises a stem fluid inlet and a stem fluid outlet. In some embodiments, the shank fluid inlet, the shank fluid outlet, the stem fluid inlet, and the stem fluid outlet are all coaxial with each other when the interchangeable shank is connected to the fill valve stem.

In some embodiments, wherein the fill valve further comprises a lever and a float. In some embodiments, a first end of the lever is connected to the diaphragm. In some embodiments, a second end of the lever is connected to the float. In some embodiments, the float is configured to actuate the diaphragm.

In some embodiments, the float includes a fluid weight chamber. In some embodiments, the fluid weight chamber comprises one or more chamber holes. In some embodiments, the one or more chamber holes are configured to enable a fluid from the tank to enter into the fluid weight chamber. In some embodiments, the one or more chamber holes are configured to enable the fluid in the fluid weight chamber to drain into the tank when a fluid level in the tank falls below the float.

In some embodiments, the disclosure is direct to an exchangeable fill valve system comprising an interchangeable shank, a threaded stem, a threaded nut, a filter, and a valve body. In some embodiments, the interchangeable shank is configured to attach to either the fill valve stem or the valve body. In some embodiments, the interchangeable shank is configured to house at least a first portion of the filter and the valve body is configured to house at least a second portion of the filter.

In some embodiments, the interchangeable shank comprises a shank conduit extending along a shank axis from a shank fluid inlet to a shank fluid outlet. In some embodiments, the valve body comprises a valve overflow and a valve outlet. In some embodiments, the valve overflow and valve outlet share a common valve axis. In some embodiments, the shank axis and valve axis are substantially perpendicular to each other.

In some embodiments, the valve body comprises a valve overflow, a valve outlet, and a float. In some embodiments, the float comprises a float recess. In some embodiments, the valve body is configured to divert at least at least a portion of fluid flowing into the valve body from the interchangeable shank flows downward through the valve outlet toward a bottom of the tank. In some embodiments, the valve body is configured to divert at least a portion of the fluid flowing into the valve body from the interchangeable shank upward through the valve overflow and into the float recess. In some embodiments, the fluid flow through the valve overflow and the valve outlet occurs simultaneously.

In some embodiments, the float recess includes a float hole configured to drain the fluid into an interior portion of the float. In some embodiments, the float further comprises a float fluid wall in the interior configured to retain at least a portion in of the fluid within the interior of the float. In some embodiments, the float further comprises a float tube guide configured to enable at least a portion of the valve body to pass therethrough. In some embodiments, at least a portion of the float tube guide comprises a radius that is less than a radius of the float fluid wall. In some embodiments, the float is configured drain the interior by to enabling the fluid drained into the interior to flow over the float fluid wall, past the float tube guide, and out of a bottom of the float.

### BRIEF DESCRIPTION OF DRAWINGS

FIG. 1 illustrates an interchangeable shank according to some embodiments.

FIG. 2 shows an isometric view of an interchangeable shank according to some embodiments.

FIG. 3 illustrates details of the quick connect shank portion of an interchangeable shank according to some embodiments.

FIG. 4 shows a portion of a fill valve including a fill valve stem configured to mate with a quick connect shank according to some embodiments.

FIG. 5 shows details of a fast fill valve configured to connect to stem according to some embodiments.

FIG. 6 shows an exploded view of a fast fill valve assembly according to some embodiments.

FIG. 7 illustrates an assembled view of the fast fill valve assembly including section line A-A according to some embodiments.

FIG. 8 illustrates a cut view of the assembled view cut along section lines A-A with a zoomed portion showing further details of the fill valve assembly according to some embodiments.

FIG. 9 shows an assembled side view of the fast fill valve assembly according to some embodiments.

FIG. 10 depicts a left view, front view, and right view of high flow valve assembly according to some embodiments.

FIG. 11 illustrates an exploded view of left view from FIG. 10 according to some embodiments.

FIG. 12 depicts a zoomed view of left view showing further details of some embodiments of valve assembly.

FIG. 13 shows a rendering of a float according to some embodiments.

FIG. 14 shows an internal view of the inner portion of the float according to some embodiments.

### DETAILED DESCRIPTION

Some embodiments include a modular fill valve system (hereafter, the “system”. In some embodiments, the system includes an interchangeable shank. In some embodiments, the interchangeable shank forms at least a portion of a water inlet feed stem for a tank fill valve. In some embodiments, the interchangeable shank enables the connection of a fill valve to a fluid source. In some embodiments, the interchangeable shank enables the connection of different types of fill valves to a fluid source. In some embodiments, the interchangeable shank enables removal and/or replacement of a fill valve without removing the interchangeable shank from the tank. In some embodiments, the interchangeable shank enables removal and/or replacement of a fill valve while the interchangeable shank remains fixed to the tank.

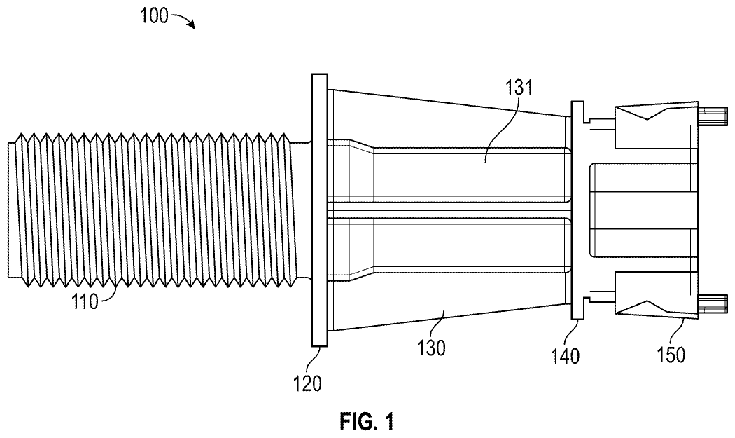

FIG. 1 illustrates an interchangeable shank 100 according to some embodiments. In some embodiments, the interchange shank 100 includes a threaded stem 110, a wall flange 120, ribs 130, a connect flange 140, and a quick connect shank 150.

In some embodiments, the threaded stem 110 is configured to connect to a complementary and conventional threaded nut (not shown) after being passed through a fill valve hole in a conventional tank (not shown). The threaded nut forces the wall flange 120 against the fill valve hole creating a seal that prevents water leakage according to some embodiments. In some embodiments, one or more seals (e.g., o-rings, gaskets, rubber washers, etc.) are placed on the threaded stem against the flange and/or the nut, against the inner and/or outer tank wall, to enable a fluid tight seal.

In some embodiments, one or more ribs 130 extend between the wall flange 120 and the connect flange 140. In some embodiments, ribs 130 provide structural support for the wall flange 120. In some embodiments, the interchangeable shank 100 is configured to be installed horizontal (i.e., parallel to the bottom of the tank). In some embodiments, ribs 130 provide support against bending moments from a fill valve connected to the quick connect shank 150. In some embodiments, the one or more ribs 130 are connected and/or integral to the rib shank 131.

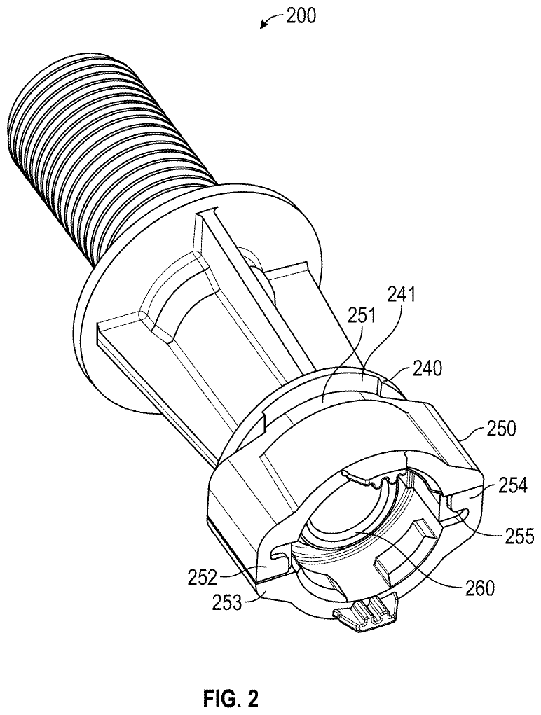

FIG. 2 shows an isometric view 200 of interchangeable shank 100 according to some embodiments. In some embodiments, the interchangeable shank 100 comprises the same components of the interchangeable shank 100 shown in FIG. 1. In some embodiments, a connect flange 240 includes one or more quick connect slots 241. In some embodiments, the quick connect slots 241 correspond to quick connect protrusions 251 extending from the lower surface of quick connect shank 250.

In some embodiments, the quick connect shank 250 is comprised of a first section 252 and a second section 253. In some embodiments, the first and/or second sections 252, 253 have an inner facing snap connection 254 and an outer facing snap connection 255. In some embodiments, the first 252 and second 253 section each have a radially extending protrusion (not shown) on their respective lower (i.e., adjacent connect flange 240) surface. In some embodiments, as the quick connect protrusion 251 on first section 252 and/or second section 253 guide sections 252, 253 toward each other, the radial extending protrusions slide underneath the quick connect flange 260. In some embodiments, as the sections 252, 253 slide into contact, snap connections 254, 255 lock quick connect shank 250 in place between connect flange 240 and quick connect flange 260.

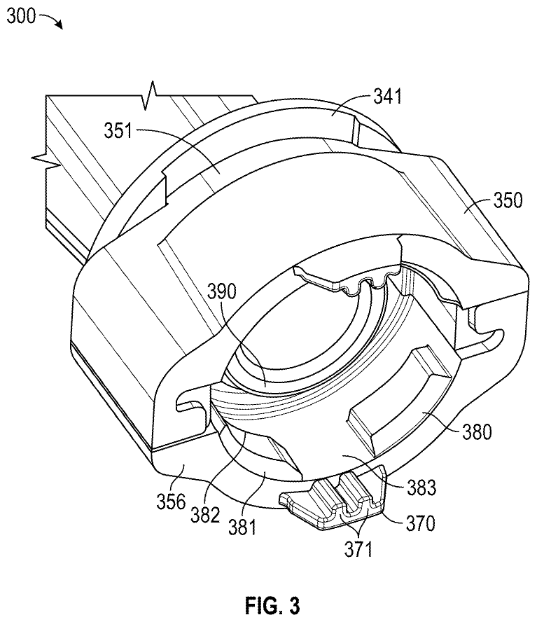

FIG. 3 illustrates further details of the quick connect shank 250 (presented as 350 for figure tracking purposes) portion of an interchangeable shank 100 (presented as 300 for figure tracking purposes) of FIGS. 1 and 2 according to some embodiments. In some embodiments, the interchangeable shank 300 comprises the same components as interchangeable shanks 100 and/or 200. In some embodiments, the quick connect shank 350 includes one or more shank tabs 370. In some embodiments, the shank tab 370 comprises one or more interference locks 371. In some embodiments, the interference lock 371 is configured to engage a stem lock to prevent rotation of a fill valve inlet stem as discussed in more detail later.

In some embodiments, the quick connect shank 350 comprises one or more shank rotation tabs 380. In some embodiments, shank rotation tabs 380 comprise an upper edge 381 and a lower edge 382. In some embodiments, edges 381 and 382 extend parallel with each other along the inner circumference of the quick connect shank. In some embodiments, edges 381 and 382 do not extend parallel with each other along the inner circumference of the quick connect shank. In some embodiments, upper edge 381 extends parallel to quick connect shank 350 upper surface 356. In some embodiments, lower edge 382 extends away from upper edge 381 and/or upper surface 356. In some embodiments, the lower edge 382 extending away is configured to cooperate with corresponding fill valve stem tabs 422 to force the fill valve stem down (i.e., towards connection flange 341) and/or against a quick connect shank O-ring (not shown) surrounding the shank fluid outlet 390.

In some embodiments, rotationally locking a stem lock 421 in place using one or more interference tabs 371 produces an audible sound (e.g., a “click”) or any other desired tactile or audible feedback. In some embodiments, a quick connect protrusion 351 engages with a quick connect slot 341 and prevents rotation of the quick connect shank 350 during the rotational locking of the stem lock 421. In some embodiments, a quick connect protrusion 351 mated with a quick connect slot 341 prevents rotation of the quick connect shank 350 during the rotational unlocking of the stem lock 421.

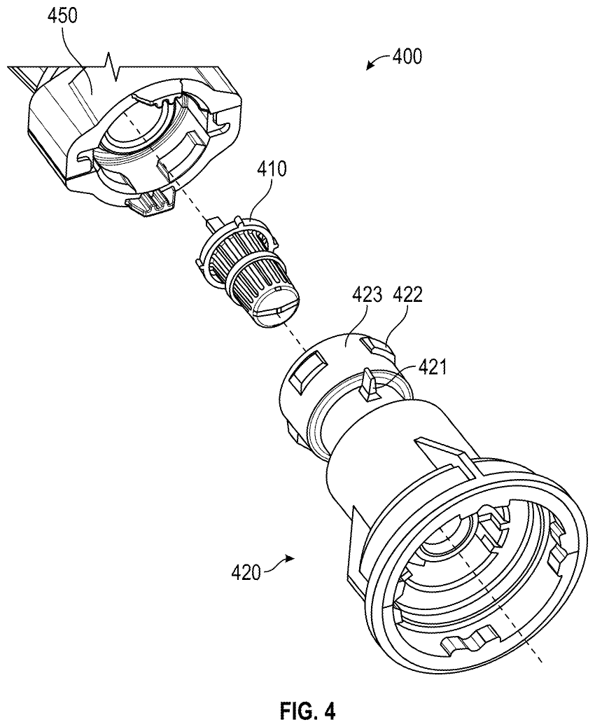

FIG. 4 shows a portion of a fill valve 400 including a fill valve stem 420 configured to mate with the quick connect shank 350 of FIG. 3 (shown as 450 for figure tracking purposes). In some embodiments, the fill valve stem comprises fill valve stem tabs 422 to force the fill valve stem inlet 423 down (i.e., towards connection flange 341) and/or against a quick shank O-ring (not shown) surrounding the shank fluid outlet 390. In some embodiments, the fill valve stem 420 comprises one or more stem locks 421. In some embodiments, the stem lock 421 mates with the one or more interference tabs 371 to rotationally lock the stem 420 as previously discussed. In some embodiments, the number of stem locks 421 equals the number of shank tabs 370. In some embodiments, the number of shank tabs 370 is two. In some embodiments, the number of interference tabs 371 per shank tab 370 is two. Other numbers of interference tabs 371 and shank tables 370 can be used in some embodiments.

In some embodiments, the interchangeable shank 100, 200, 300 is configured to receive a removable and/or serviceable filter 410. In some embodiments, filter 410 is configured to fit inside fluid outlet 390. In some embodiments, the filter 410 fitted inside fluid outlet 390 enables the same filter to be used with different fill valves that are each configured to connect to interchangeable shank 300.

In some embodiments, the stem 420 is configured to receive a removable and/or serviceable filter 410. In some embodiments, the stem 420 configured to receive a filter 410 is configured to connect to multiple fill valve types. In some embodiments, the filter 410 is fixed in position inside stem 420 when the stem lock 421 engages the interference tabs 371. In some embodiments, stem 420 is configured to be rotationally unlocked by twisting the stem in the opposite direction. In some embodiments, rotating in the opposite direction causes stem lock 421 to slide over one or more interference tabs 371, making an audible sound or any tactile feedback. In some embodiments, unlocking the stem allows for filter 410 to be removed, replaced and/or cleaned.

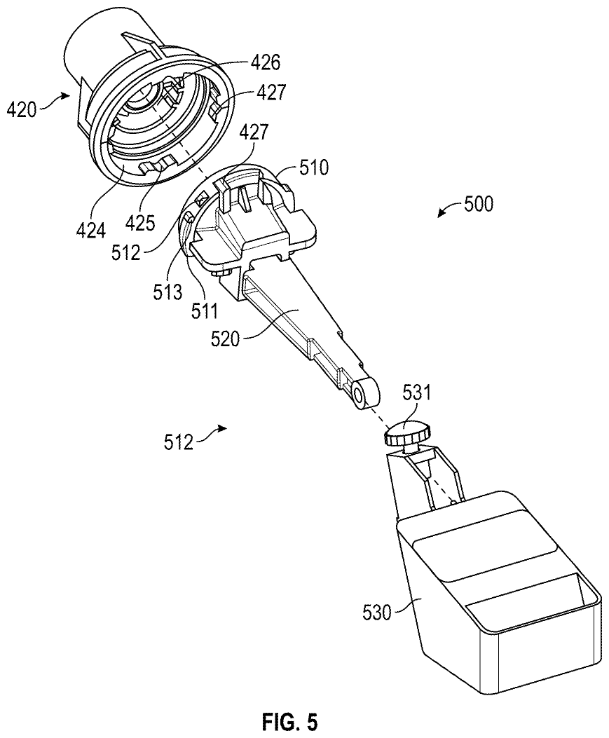

FIG. 5 shows details of a fast fill valve 500 configured to connect to stem 420 according to some embodiments. In some embodiments, the stem 420 includes the filter 410. In some embodiments, fast fill valve 500 includes a valve housing 510, a fast fill lever 520, and/or a fast float 530. In some embodiments, the stem 420 includes one or more valve tab slots 424 configured to align with one or more valve tabs 511. In some embodiments, the stem 420 includes one or more valve tab recesses 425 configured to align with valve tab protrusions 512. In some embodiments, fast fill valve 500 valve housing 510 is at least partially configured to be inserted into stem 420. In some embodiments, one or more of the valve tabs 511 and/or tab slots 512 include an inclined surface 513 configured to move the fast fill valve down (i.e., against stem 420) and/or against stem O-ring 426 as housing 510 is rotated. In some embodiments, as the housing 510 is rotated, the inclined surface 513 is configured to guide and/or force valve tabs 511 and/or tab slots 512 are underneath one or more stem locks 427. In some embodiments, housing 510 is configured to be rotated until rotation stop 427 engages one or more stem locks 427.

In some embodiments, fast fill lever 520 controls actuation of fast fill valve 500. In some embodiments, controlling actuation controls the fluid flow through fast fill valve 500. In some embodiments, the fast fill valve 500 includes a float assembly 530. In some embodiments, the float assembly 530 is configured to raise the lever 520 in response to the water lever in a tank rising to the level of the float 530. In some embodiments, raising the lever 520 is configured to stop the fluid flow through fast fill valve 500. In some embodiments, lowering the lever is configured to allow fluid flow through fast fill valve 500.

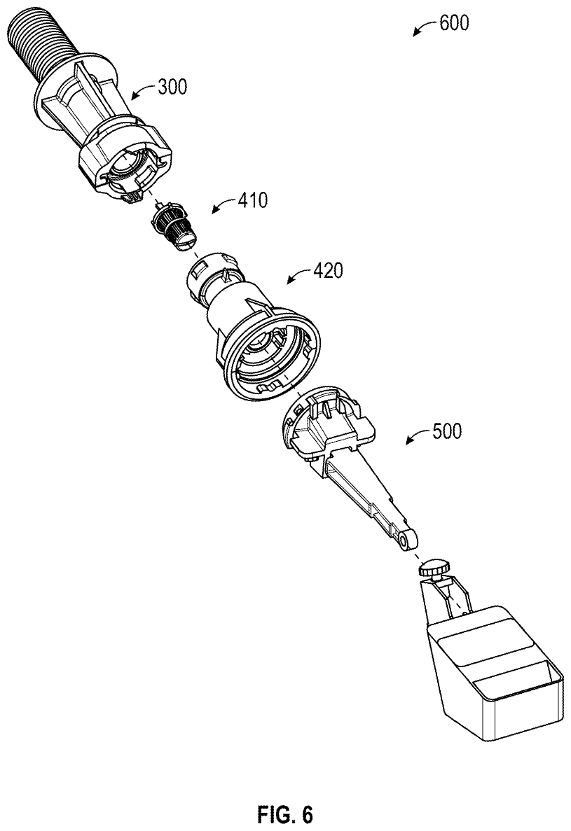

FIG. 6 shows an exploded view of a fast fill valve assembly 600 according to some embodiments. In some embodiments, the fast fill valve assembly includes an interchangeable shank 300, filter 410, valve stem 420, and fast fill valve 500 as previously discussed.

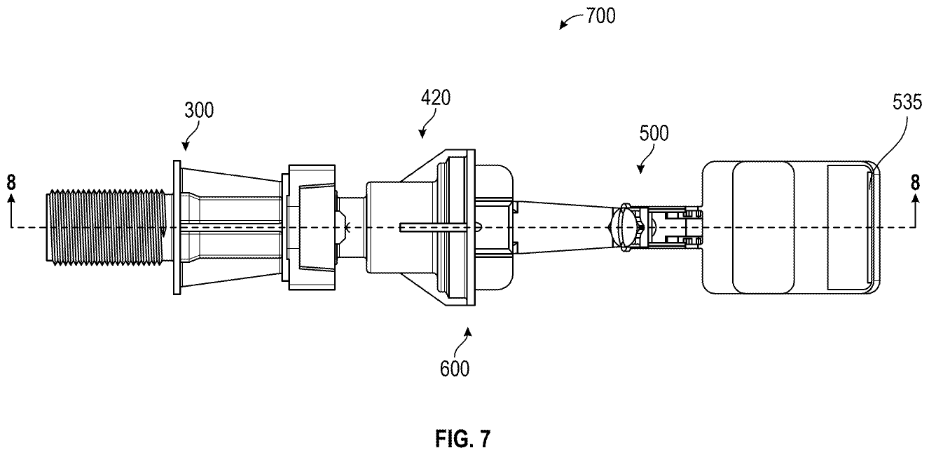

FIG. 7 illustrates an assembled view 700 of the fast fill valve assembly 600 including section line A-A. In some embodiments, the fast fill valve assembly includes an interchangeable shank 300, valve stem 420, and fast fill valve 500 as previously discussed.

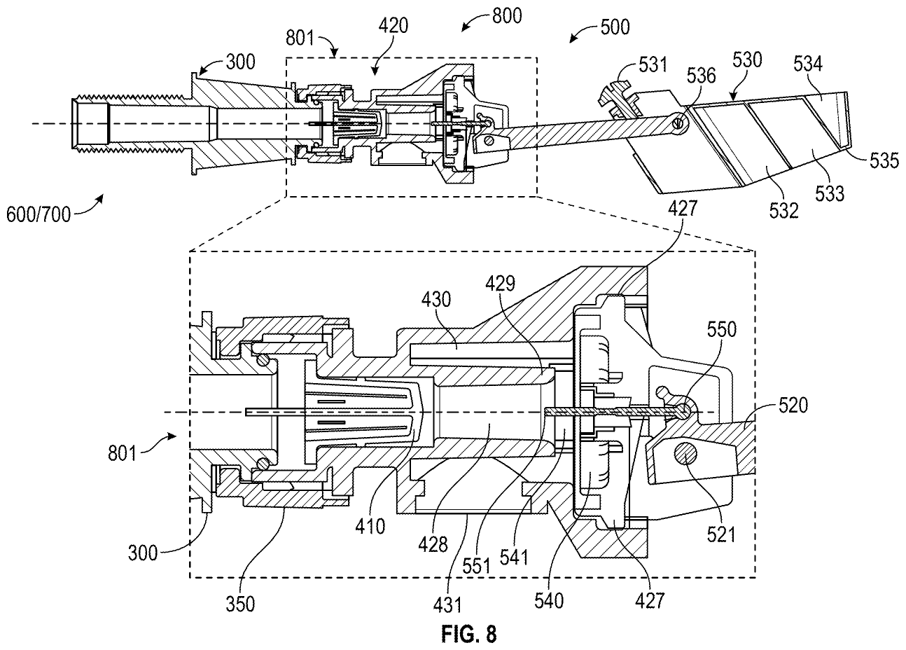

FIG. 8 illustrates a cut view 800 of the assembled view 700 cut along section lines A-A with a zoomed portion 801 showing further details of the fill valve assembly 600. In some embodiments, zoomed portion 801 shows filter 410 at least partially housed within quick connect shank 350 which is attached to and/or a part of interchangeable shank 300. In some embodiments, fluid flows through filter 410 into valve stem inlet 428. In some embodiments, an inlet seal 541 of a diaphragm 540 seals the inlet edge 429 of inlet 428 when the lever 520 is in an upper position (i.e., toward the top of a tank and/or a water level's upper surface). In some embodiments, as lever 520 is rotated downward about pivot pin 521, the downward (i.e., toward the bottom of the tank) motion is configured to cause the diaphragm pin 550 distal end 551 to retreat into the diaphragm 540. In some embodiments, the retreat allows inlet seal 541 to disengage from inlet edge 429. In some embodiments, the pressure of incoming fluid forces inlet seal 541 and/or one or more other portions of diaphragm 540 to flex away from the fluid pressure. In some embodiments, as the diaphragm moves away fluid flow past inlet seal 541 into stem outlet passage 430 and out the fast fill valve assembly 600 through outlet 431.

In some embodiments, actuation of lever 520 can be controlled by level control 531. In some embodiments, level control 531 is configured to control the rotation of float 530 about float pin 536. In some embodiments, the level control 531 is a screw. In some embodiments, the float 530 is locked from rotation about pin 536 when the level control is fully extended. In some embodiments, the float 530 is free to rotate about pin 536 when the level control is fully retracted. In some embodiments, the angle of rotation is between 0 and 30 degrees.

In some embodiments, when the level control 531 is extended the lever 520 is lifted by rising fluid sooner than if the level control 531 is retracted. In some embodiments, when the level control 531 is extended the compartments 532 and/or 533 are closer to the surface of the water than when the level control 531 is retracted. In some embodiments, as the water rises, the float is configured to become buoyant due to the fluid trapping air inside compartments 532 and/or 533. In some embodiments, fluid level continues to rise until lever 520 is lifted to its full extent which seals inlet 428 as previously discussed.

In some embodiments, when the level control 531 is retracted the float 530 is freely rotated about pin 536. In some embodiments, this rotation allows more time before lever 520 is lifted and fluid flow stops. In some embodiments, this rotation is configured to allow the fast fill valve to continue to add fluid to a tank until the rotation is stopped by the level control 531. In some embodiments, a retracted level control 531 is results in a higher fluid level than an extended level control.

In some embodiments, the float 530 includes a fluid weight chamber 534. In some embodiments, fluid enters chamber holes 535 when a fluid level reaches the float 530. In some embodiments, when a tank fluid level drops, the weight chamber 534 is configured to use the weight of the fluid held within to force the lever 520 downward and/or actuate diaphragm 540 and/or inlet seal 541. In some embodiments, one or more chamber holes 535 (shown as slot 535 in FIG. 7) within one or more walls of fluid weight chamber 534 are configured to provide a controlled discharge of water out of chamber 534 when a fluid level in a tank falls below a bottom level of the float. In some embodiments, fluid draining out of fluid weight chamber 534 is configured to make float 530 more buoyant to enable raising of the lever 520 when the tank fluid level reaches the float. In some embodiments, the one or more chamber holes 535 are configured to maintain the chamber 535 fluid level the same as the tank fluid level during a tank filling operation.

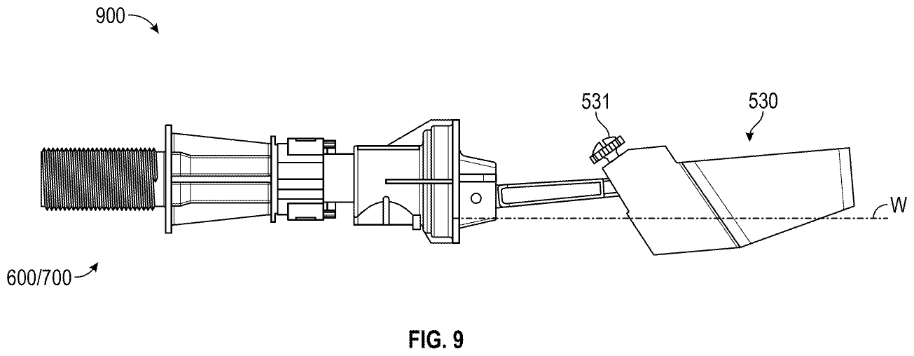

FIG. 9 shows an assembled side view 900 of the fast fill valve assembly 600, 700 according to some embodiments. In some embodiments, a retracted configuration (e.g., unscrewed) for level control 531 allows for float 530 to raise higher than an extended configuration for level control 531 which results in increased fluid tank filling.

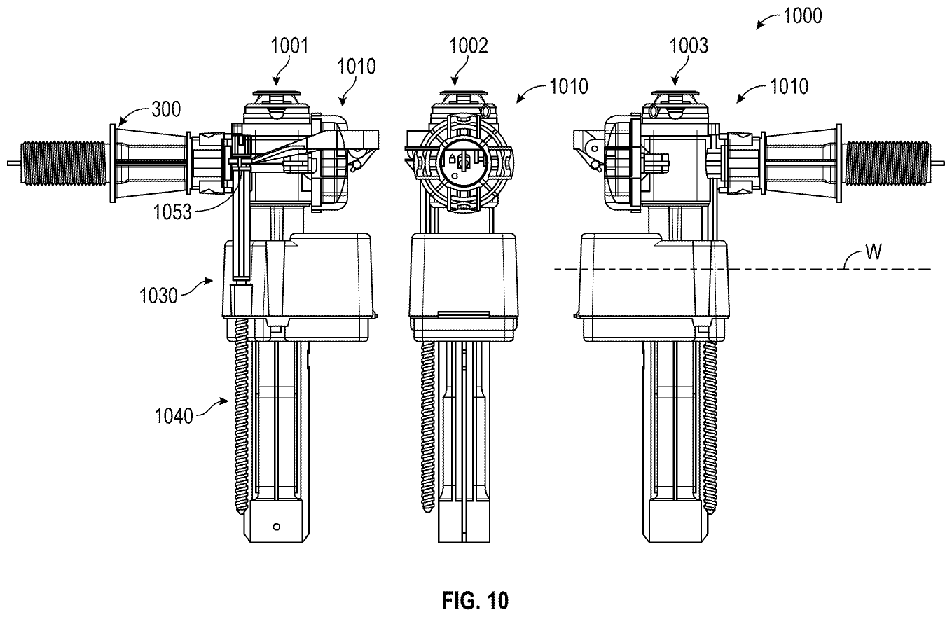

FIG. 10 depicts a left view 1001, front view 1002, and right view 1003 of high flow valve assembly 1000 according to some embodiments. In some embodiments, the assembly 1000 includes an interchangeable shank 300 (as previously described), a valve body 1010, a float 1030, and a level control 1040 in each view 1001, 1002, and/or 1003. Also shown is an approximate fluid level W, as well as a lever arm connection 1053 according to some embodiments.

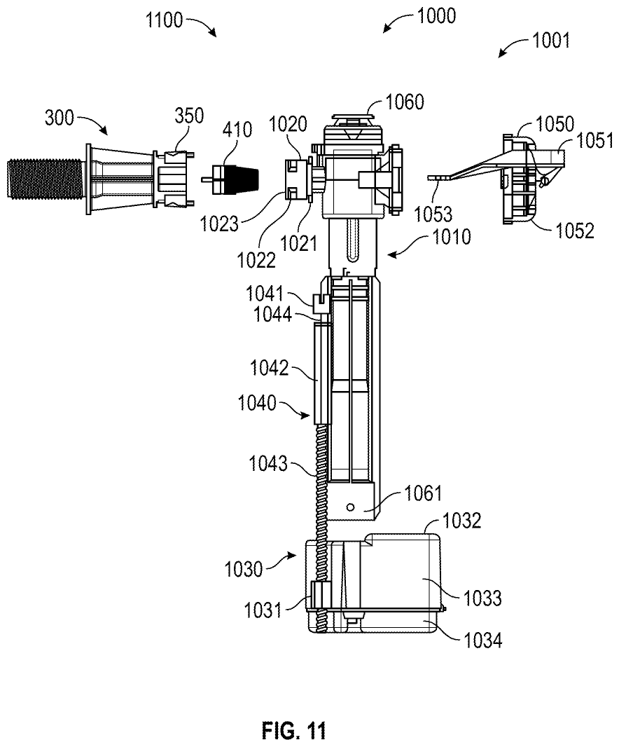

FIG. 11 illustrates an exploded view 1100 of left view 1001 from FIG. 10 according to some embodiments. In some embodiments, filter 410 is inserted into at least a portion of valve stem 1020 and/or interchangeable shank 300 as previously discussed. In some embodiments, the stem 1020 is configured to receive the removable and/or serviceable filter 410. In some embodiments, multiple fill valve types include a stem 1020 configured to receive filter 410. In some embodiments, the filter 410 is fixed in position inside stem 1020 when the one or more stem locks 1021 engages the interference tabs 471. In some embodiments, stem 1020 can be rotationally unlocked by twisting the stem 1020 in the opposite direction. In some embodiments, rotating in the opposite direction causes stem lock 421 to slide over one or more interference tabs 471, making an audible sound. In some embodiments, unlocking the stem allows for filter 410 to be removed, replaced and/or cleaned.

In some embodiments, the high flow stem 1020 comprises high flow stem tabs 1022 to move the fill valve stem inlet 1023 inward (i.e., towards connection flange 341) and/or against a quick shank O-ring (not shown) surrounding the shank fluid outlet 390. In some embodiments, the stem lock 1021 mates with the one or more interference tabs 371 to rotationally lock the stem 1020 as previously discussed. In some embodiments, the number of stem locks 1021 equals the number of shank tabs 370. In some embodiments, the number of shank tabs 370 is two. In some embodiments, the number of interference tabs 371 per shank tab 370 is two.

In some embodiments, the float 1030 is attached to the high flow valve body 1010 by way of level control 1040. In some embodiments, level control 1040 includes one or more tool fittings 1041, finger grips 1042, and/or adjustment threads 1043. In some embodiments, rotation of the level control 1040 in one direction raises the float 1030. In some embodiments, rotation of the level control in the other direction lowers float 1030. In some embodiments, the level control is configured to engage a tool (e.g., a conventional screwdriver or other suitable tool; not shown) such that the rotation of the tool rotates the level control 1040. In some embodiments, an uneven surface (e.g., raised grooves, protrusions, and/or recesses) on finger grip 1042 enable provide a greater contact surface area with a finger which results in an improved grip. In some embodiments, rotation of the finger grip enables raising or lowering float 1030 as previously discussed.

In some embodiments, valve assembly 1000 includes a valve 1050. In some embodiments, valve 1050 includes a lever 1051 connected to a valve body 1052. In some embodiments, the lever 1051 is connected at a distal end 1053 to the level control 1040 at lever connection 1044. In some embodiments, raising and lowering of the lever control 1044 controls the actuation of valve 1050 by controlling a conventional diaphragm (not shown) in a similar manner as described with regard to zoomed portion 801 in FIG. 8.

In some embodiments, when the distal end 1053 is raised (i.e., toward overflow 1060) the diaphragm unseals the valve inlet (as previously described) and fluid flows from the interchangeable shank 300 through filter 410, past the diaphragm (not shown) and into the valve body 1010 (an embodiment shown in further detail later). Water then flows out through overflow 1060 and/or outlet 1061.

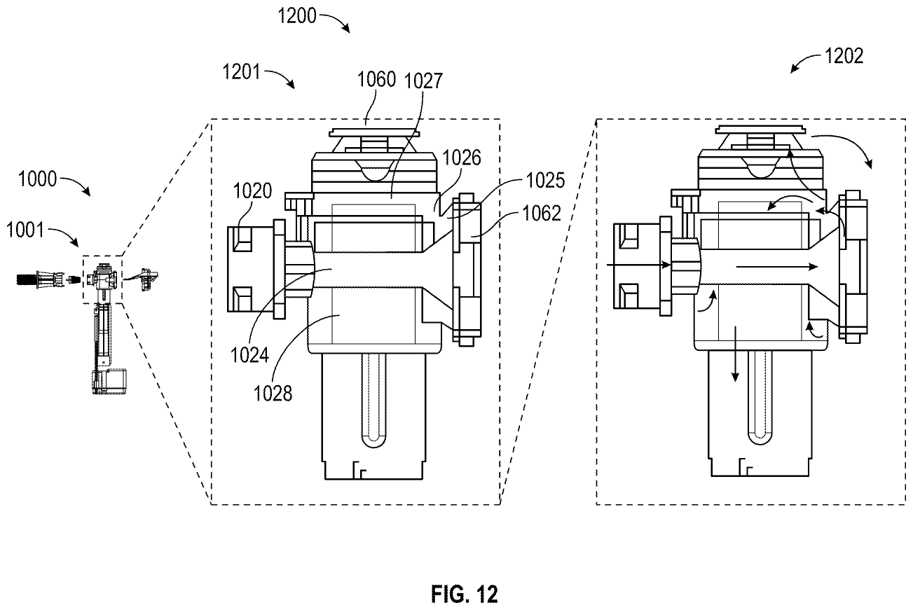

FIG. 12 depicts a zoomed view 1200 of left view 1001 showing further details of some embodiments of valve assembly 1000. In some embodiments, structure view 1201 shows details of inner components of valve body 1010. In some embodiments, flow view 1202 show arrows demonstrating approximate fluid flow around and through components of valve body 1010. In some embodiments, fluid flows in through valve stem 1020, through main outlet 1022 (i.e., the solid tube passes though the outlet tube) where it meets the diaphragm (not shown) at stem outlet 1024. In some embodiments, when distal end 1053, control lever 1040, and/or float 1030 is in the lower position, the diaphragm (the interface of which against outlet 1025 is the similar to that of outlet 429 as previously described) allows fluid to flow out outlet 1025 and into chamber 1026. As chamber 1026 fills, fluid is directed by the walls of the chamber through tank inlet 1027 and/or overflow 1060. In some embodiments, the water flows through tank tube 1028, tube body 1062, and out tube outlet 1061 (FIG. 11) into a conventional tank (not shown).

As previously described, in some embodiments, an inlet seal 541 of a diaphragm 540 seals the inlet edge 1025. In some embodiments, the inlet edge 1025 is sealed when the lever distal end 1053 is in an upper position (i.e., toward the top of a tank and/or a water level's upper surface). In some embodiments, as lever 1051 is rotated downward about a pivot pin (not shown), the downward (i.e., toward the bottom of the tank) lever 1051 motion is configured to cause the diaphragm pin 550 distal end 551 to retreat into the diaphragm 540. In some embodiments, the retreat allows inlet seal 541 to disengage from inlet edge 1025. In some embodiments, the pressure of incoming fluid forces inlet seal 541 and/or one or more other portions of diaphragm 540 to flex away from the fluid pressure. In some embodiments, as the diaphragm moves away fluid flow past inlet seal 541 into chamber 1026.

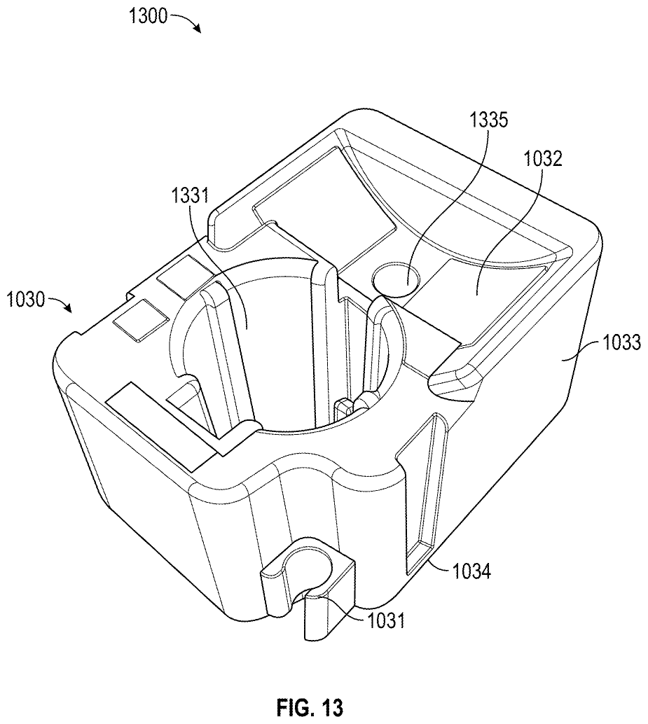

FIG. 13 shows a rendering 1300 of float 1030 according to some embodiments. In some embodiments, the float 1030 includes a tube guide 1331 which is configured to allow tube body 1062 to pass therethrough. In some embodiments, float 1030 comprises a recess 1032 with a recess hole 1335 that leads inside the hollow body 1033. In some embodiments, fluid flowing out of overflow 1060 fills recess 1032 with fluid. In some embodiments, the fluid in recess 1032 drains through hole 1335 and at least partially fills body 1033. In some embodiments, the internal fluid is used as a weight to assist in lowering the lever 1051. In some embodiments, the weight assists the diaphragm in moving away from outlet 1025 and allowing water to fill chamber 1026 as previously described.

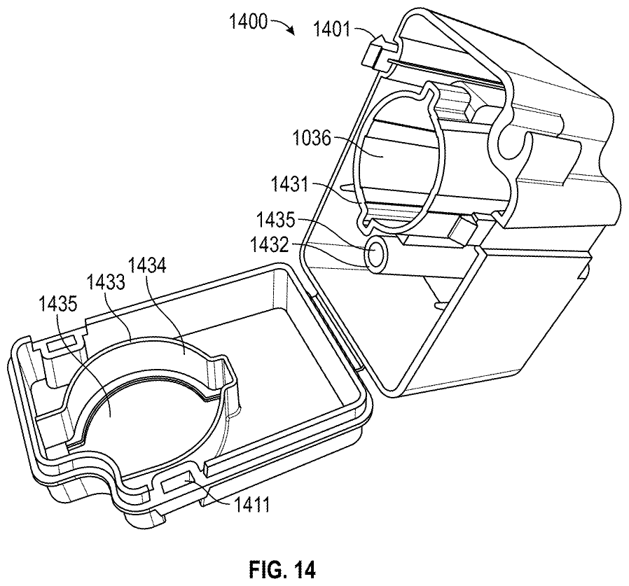

FIG. 14 shows an internal view 1400 of the inner portion of float 1030. In some embodiments, at least a portion of tube guide 1036 outer wall 1431 has a radius that is less than a radius of fluid wall 1434. In some embodiments, an air gap separates tube guide 1036 wall 1431 and fluid wall 1434. In some embodiments, as fluid fills the float 1030 inner portion, the fluid wall 1434 is configured to allow fluid to flow over edge 1433 and out guide tube bottom hole 1435. In some embodiments, the hole 1335 allows air to enter the inner portion while fluid is draining from the inner portion. In some embodiments, allowing fluid to drain from the inner portion enables the float 1030 to be more buoyant during a filling operation. In some embodiments, one or more fasteners 1410 engage with one or more fastener connections 1411 to at least partially seal inner portions of float 1030.

The previous detailed description is to be read with reference to the figures, in which like elements in different figures have like reference numerals. The figures, which are not necessarily to scale, depict some embodiments and are not intended to limit the scope of embodiments of the system.

Some embodiments of the system are presented with specific values and/or setpoints. These values and setpoints are not intended to be limiting and are merely examples of a higher configuration versus a lower configuration and are intended as an aid for those of ordinary skill to make and use the system.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured, or ±5° when used in conjunction with angles.

“Simultaneously” as used herein includes lag and/or latency times associated with fluid reaching different destination along different flow paths.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited.

Still further, acting as Applicant's own lexicographer, Applicant reserves the right to use relative terms (e.g., “high”, “strong,” “hot,” etc.) as part of a proper name for a structure both in the specification and in the claims. The relative term portion of the proper name is not a limitation but is instead used to maintain consistency between terms used in the written description and terms used in the claims. However, this use of a relative term within a proper name does not limit the claim to any embodiment that the term is associated with in the written description.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Modifications to the illustrated embodiments and the generic principles herein can be applied to all embodiments and applications without departing from embodiments of the system. Also, it is understood that features from different embodiments presented herein can be combined to form new embodiments that fall within the disclosure. Thus, embodiments of the system are not intended to be limited to embodiments shown, but are to be accorded the widest scope consistent with the principles and features disclosed herein.

1. An exchangeable fill valve system comprising:
an interchangeable shank,
a threaded stem,
a threaded nut,
a filter, and
a fill valve stem,
wherein the interchangeable shank comprises the threaded stem;
wherein the threaded stem is configured to cooperate with the threaded nut to secure the interchangeable shank to a tank wall;
wherein the interchangeable shank is configured to house at least a first portion of the filter; and
wherein the fill valve stem is configured to house at least a second portion of the filter.

2. The exchangeable fill valve system of claim 1,
where the interchangeable shank is configured to be installed horizontal relative to a bottom of the tank.

3. The exchangeable fill valve system of claim 1,
further comprising a fill valve;
wherein the fill valve comprises a diaphragm configured to control a fluid flow through the interchangeable shank and the fill valve stem; and
wherein the interchangeable shank is configured to connect to the fill valve stem.

4. The exchangeable fill valve system of claim 3,
wherein the fill valve further comprises:
a lever,
a pin, and
an inlet seal;
wherein the fill valve stem further comprises:
a stem inlet, and
an inlet edge;
wherein actuation of the lever causes the pin to pull the inlet seal from the inlet edge of the inlet.

5. The exchangeable fill valve system of claim 4,
wherein the fill valve further comprises a float; and
wherein at least a portion the interchangeable shank, the filter, the fill valve stem, the lever, and the float are located along a common plane when the exchangeable fill valve system is assembled.

6. The exchangeable fill valve system of claim 5,
wherein the common plane is configured to be substantially parallel to a bottom of the tank.

7. The exchangeable fill valve system of claim 1,
wherein the interchangeable shank comprises a shank fluid inlet and a shank fluid outlet;
wherein the fill valve stem comprises a stem fluid inlet and a stem fluid outlet;
wherein the shank fluid inlet, the shank fluid outlet, the stem fluid inlet, and the stem fluid outlet are all coaxial with each other when the interchangeable shank is connected to the fill valve stem.

8. The exchangeable fill valve system of claim 3,
wherein the fill valve further comprises:
a lever, and
a float;
wherein a first end of the lever is connected to the diaphragm;
wherein a second end of the lever is connected to the float;
wherein the float is configured to actuate the diaphragm; and
wherein the float includes a fluid weight chamber.

9. The exchangeable fill valve system of claim 8,
wherein the fluid weight chamber comprises one or more chamber holes;
wherein the one or more chamber holes are configured to enable a fluid from the tank to enter into the fluid weight chamber; and
wherein the one or more chamber holes are configured to enable the fluid in the fluid weight chamber to drain into the tank when a fluid level in the tank falls below the float.

10. An exchangeable fill valve system comprising:
an interchangeable shank,
a threaded stem,
a threaded nut,
a filter, and
a valve body,
where the interchangeable shank comprises the threaded stem;
where the threaded stem is configured to cooperate with the threaded nut to secure the interchangeable shank to a tank wall;
wherein the interchangeable shank is configured to house at least a first portion of the filter; and
wherein the valve body is configured to house at least a second portion of the filter.

11. The exchangeable fill valve system of claim 10,
wherein the interchangeable shank comprises a shank conduit extending along a shank axis from a shank fluid inlet to a shank fluid outlet.

12. The exchangeable fill valve system of claim 11,
wherein the valve body comprises a valve overflow and a valve outlet; and
wherein the valve overflow and valve outlet share a common valve axis.

13. The exchangeable fill valve system of claim 12,
wherein the shank axis and valve axis are substantially perpendicular to each other.

14. The exchangeable fill valve system of claim 13,
wherein the valve body further comprises a float; and
wherein the float is configured to move parallel to the valve axis.

15. The exchangeable fill valve system of claim 10,
wherein the valve body comprises:
a valve overflow,
a valve outlet, and
a float;
wherein the float comprises a float recess; and
wherein the valve body is configured to:
divert at least at least a portion of fluid flowing into the valve body from the interchangeable shank flows downward through the valve outlet toward a bottom of the tank; and
divert at least a portion of the fluid flowing into the valve body from the interchangeable shank upward through the valve overflow and into the float recess.

16. The exchangeable fill valve system of claim 15,
wherein the fluid flow through the valve overflow and the valve outlet occurs simultaneously.

17. The exchangeable fill valve system of claim 15,
wherein the float recess includes a float hole configured to drain the fluid into an interior portion of the float.

18. The exchangeable fill valve system of claim 17,
wherein the float further comprises a float fluid wall in the interior configured to retain at least a portion in of the fluid within the interior.

19. The exchangeable fill valve system of claim 18,
wherein the float further comprises a float tube guide configured to enable at least a portion of the valve body to pass therethrough.

20. The exchangeable fill valve system of claim 19,
wherein at least a portion of the float tube guide comprises a radius that is less than a radius of the float fluid wall; and
wherein the float is configured drain the interior by to enabling the fluid drained into the interior to flow over the float fluid wall, past the float tube guide, and out of a bottom of the float.
